(19) United States
(12) Patent Application Publication
(10) Pub. No.: US 2014/0344155 A1
(43) Pub. Date: Nov. 20, 2014

(54) OUT OF BAND AUTHENTICATION AND AUTHORIZATION PROCESSING

(71) Applicants: Frederick Liu, Oakland, CA (US); Shaw Li, San Francisco, CA (US); Glenn Powell, Fremont, CA (US); Mark Nelsen, Oakland, CA (US)

(72) Inventors: Frederick Liu, Oakland, CA (US); Shaw Li, San Francisco, CA (US); Glenn Powell, Fremont, CA (US); Mark Nelsen, Oakland, CA (US)

(21) Appl. No.: 14/280,498

(22) Filed: May 16, 2014

Related U.S. Application Data
(60) Provisional application No. 61/824,206, filed on May 16, 2013.

(51) Int. Cl. G06Q 20/40; G06Q 20/32

(52) U.S. Cl. CPC G06Q 20/4016; G06Q 20/3227
USPC 705/44

(57) ABSTRACT

Methods and systems for providing data retrieved and analyzed as part of an authentication process for a user device to other entities of a transaction system are disclosed. This data can be used by other entities of the transaction system to enable more secure authorization processes for transactions. A risk score generated for a payment application server computer and the data used to generate the risk score can be leveraged to provide an issuer with more detailed data to ensure that the user engaging in a transaction is authenticated and that transactions being processed by the issuer are not fraudulent.

### CROSS-REFERENCES TO RELATED APPLICATIONS

This application claims the benefit of priority U.S. Provisional Application No. 61/824,206, filed May 16, 2013, titled “OUT OF BAND AUTHENTICATION AND AUTHORIZATION PROCESSING,” which is incorporated by reference in its entirety for all purposes.

### BACKGROUND

The use of user devices, such as mobile phones, tablet computers and desktop computers, to perform transactions, has become commonplace. Correspondingly, the risk of fraudulent transactions being conducted has increased as more transactions are being conducted without merchants ever seeing the user of the user device (e.g., the consumer).

Currently, authentication processes may be performed to determine whether the user device is authentic and/or the user conducting a transaction with the user device is the legitimate user and not a fraudster. These current methods are limited in that while a merchant or payment application (e.g., digital wallet) may be provided with the result of these authentication processes and decide to proceed or stop a transaction based on the result of an authentication process, not all parties to a transaction may be provided with the same information. Accordingly, there is a need for payment processing systems to leverage the additional information into their authentication, validation, and verification systems to provide more secure and transaction processes.

Embodiments of the present invention address the above problems and other problems.

### BRIEF SUMMARY

Embodiments of the present invention are directed to systems and methods for providing authentication data for a user device to an authorization system prior to the authorization process for a transaction in order to enhance the authorization process for the transaction. For example, the risk scoring system may receive device information for a user device and perform a risk analysis to generate a first risk score. The first risk score may be transmitted back to the requester and to a payment processing network server computer for storage. The requester may use the first risk score whether to proceed with the transaction. The requester may generate and send an authorization request message for the transaction to the payment processing network server computer. The payment processing network server computer may then match the authorization request message to the first risk score received from the risk scoring system. The payment processing network server computer may then generate a second risk score using transaction data in the authorization request message and the first risk score. The payment processing network server computer may then send the second risk score to an issuer computer for authorization decisioning. Embodiments of the present invention provide additional data to the payment processing network and the issuer computer than would typically be sent in authorization messages. The additional data sent by the risk scoring system improves the transaction decisioning process and reduces the risk of processing and authorizing fraudulent transactions.

One embodiment of the present invention is directed to a method comprising receiving at least one of information from a user device and a first risk score generated by a first risk scoring system. The first score is generated by the first risk scoring system after receiving the information from the user device. The method further comprises storing at least one of the first risk score and the information from the user device in a database. The method further comprises receiving an authorization request message including transaction data for a transaction. The first risk score or the information from the user device is then retrieved from the database, and matched with the authorization request message. The method further comprises generating a second risk score for the transaction based on the transaction data and the first risk score or the information from the user device, modifying the authorization request message to include the second risk score. The method further comprises transmitting the modified authorization request message to an issuer computer for an authorization determination.

Another embodiment of invention is directed to a server computer comprising a processor and a computer readable medium coupled to the processor, the computer readable medium comprising code, executable by the processor for implementing a method. The method comprises receiving at least one of information from a user device and a first risk score generated by a first risk scoring system. The first score is generated by the first risk scoring system after receiving the information from the user device. The method further comprises storing at least one of the first risk score and the information from the user device in a database. The method further comprises receiving an authorization request message including transaction data for a transaction. The first risk score or the information from the user device is then retrieved from the database, and matched with the authorization request message. The method further comprises generating a second risk score for the transaction based on the transaction data and the first risk score or the information from the user device, modifying the authorization request message to include the second risk score. The method further comprises transmitting the modified authorization request message to an issuer computer for an authorization determination.

Another embodiment of the present invention is directed to a method comprising receiving a risk score request message from a payment application server computer. The risk score request message may include transaction details for a transaction and device information for a user device being used to conduct the transaction and associated with the payment application server computer. The method further comprises performing a first risk analysis for the user device based on the transaction details and the device information for the user device, and generating a first risk score based on the first risk analysis. The method further comprises sending a risk score response message including the first risk score to the payment application server computer; and transmitting the first risk score and the device information to a second server computer.

Another embodiment of invention is directed to a server computer comprising a processor and a computer readable medium coupled to the processor, the computer readable medium comprising code, executable by the processor for implementing a method. The method comprises receiving a risk score request message from a payment application server computer. The risk score request message may include transaction details for a transaction and device information for a user device being used to conduct the transaction and associated with the payment application server computer. The method further comprises performing a first risk analysis for the user device based on the transaction details and the device information for the user device, and generating a first risk score based on the first risk analysis. The method further comprises sending a risk score response message including the first risk score to the payment application server computer; and transmitting the first risk score and the device information to a second server computer.

Another embodiment of the present invention is directed to a method comprising receiving device information for a user device associated with a transaction. The method further comprises sending a risk score request message including transaction details for the transaction and the device information for the user device to a risk scoring system. A first risk score for the user device is received from the risk scoring system. The method further comprises evaluating the first risk score for the user device to determine whether to proceed with the transaction. The method further comprises determining that the transaction should proceed, and generating and sending an authorization request message for the transaction to a second server computer.

Another embodiment of invention is directed to a server computer comprising a processor and a computer readable medium coupled to the processor, the computer readable medium comprising code, executable by the processor for implementing a method. The method comprises receiving device information for a user device associated with a transaction. The method further comprises sending a risk score request message including transaction details for the transaction and the device information for the user device to a risk scoring system. A first risk score for the user device is received from the risk scoring system. The method further comprises evaluating the first risk score for the user device to determine whether to proceed with the transaction. The method further comprises determining that the transaction should proceed, and generating and sending an authorization request message for the transaction to a second server computer.

These and other embodiments of the present invention are described in further detail below with reference to the Drawings and the Detailed Description.

### BRIEF DESCRIPTION OF THE DRAWINGS

FIG. 1 shows a system diagram for a transaction processing system according to an embodiment of the present invention.

FIG. 2 depicts an exemplary block diagram of a risk scoring system according to an embodiment of the present invention.

FIG. 3 shows an example device data and risk score database according to an embodiment of the present invention.

FIG. 4 shows an example message flow diagram for an authentication and authorization process for a transaction according to an embodiment of the present invention.

FIG. 5 depicts an exemplary block diagram of a user device in the form of a mobile communication device according to an embodiment of the present invention.

FIG. 6 shows a block diagram of a computer apparatus according to an embodiment of the present invention.

### DETAILED DESCRIPTION

Prior to discussing embodiments of the present invention, descriptions of some terms may be helpful in providing a better understanding of the present invention.

A “user device” may include a device that can be used to communicate with another device or system. For example, suitable user devices can be hand-held and compact so that it can fit into a user's wallet and/or pocket (e.g., pocket-sized). The user device can include a processor, and memory, input devices, and output devices, operatively coupled to the processor. Specific examples of user devices include cellular or mobile phones, tablet computers personal digital assistants (PDAs), pagers, portable computers, smart cards, and the like. The user device may be capable of conducting communications over a network. The communications can include transmission and reception of messages used to conduct a transaction such as, for instance, a purchase of goods or services. It can include a device that is used to conduct a transaction such as a transfer of funds. A user device may be in any suitable form. The user device may also be referred to as a mobile device, mobile communication device, or a consumer mobile device.

The term “message” may refer to any data or information that may be transported from one entity to another entity (e.g., from one computer or computing device to another computer or computing device). Further, a message may include a single signal or data packet or a combination of multiple transporting signals. For example, a message may include an analog electrical signal or digital signal that constitutes binary information that may be interpreted as communicating information. Messages may be communicated internally between devices within a secure organization or externally between a device within a secure organization or network to a device outside of a secure organization, area, or communication network. Additionally, messages may be modified, altered, or otherwise changed to comprise encrypted or anonymized information.

The term “user” may refer to an individual or entity. The user may be a consumer or business that is associated with a financial account that can be used to conduct financial transactions using a payment device associated with the financial account.

The term “transaction” may refer to an exchange of interaction between two entities. In some embodiments, a transaction may refer to transfer of value between two users (e.g., individuals or entities). A transaction may involve the exchange of monetary funds, or the exchange of goods or services for monetary funds between two individuals or entities. In other embodiments, a transaction may involve an individual or entity purchasing goods or services from a merchant or other entity in exchange for monetary funds.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

The term “payment application” may refer to an application or software that facilitates a transaction. In some embodiments, a payment application may be a wallet application stored in a memory or secure element of a user device (e.g., a mobile phone, desktop computer, tablet computer). In other embodiments, the payment application may be an interface on a merchant's website that allows a user to enter payment data for submission for processing a transaction.

The term “database” may include any hardware, software, firmware, or combination of the preceding for storing and facilitating the retrieval of information. In addition, the database may use any of a variety of data structures, arrangements, and compilations to store and facilitate the retrieval of information.

The term “filtering logic operation” may refer to a process conducted on data to retrieve data. In some embodiments, the filtering logic operation may analyze an authorization request message for a transaction and determine data stored a device data and risk score database that matches or correlates to the transaction. The filtering logic operation may use one or more a transaction time, an authorization request message time, and a risk score generation time to match the authorization request message with the appropriate risk score and device data for the transaction.

The term “issuer computer” may include an entity that issues an account. An issuer is typically a business entity (e.g., a bank) which maintains financial accounts for a plurality of users (e.g., consumers).

The term “user data” may refer to data regarding a user or consumer. User data may include a name, mailing address, shipping address, email address, phone number, payment account number, date of birth, marital status, income, social security number, demographic data, etc. In some embodiments, user data may also include consumer preferences, notification methods, and prior transaction history. In some embodiments, user data may be stored by a risk scoring system. The stored user data may be used as part of a risk evaluation or risk analysis.

The term “risk scoring system” may refer to a system or computer configured to generate a risk score. In some embodiments, the risk scoring system may be a computer configured to receive data, retrieve or receive risk data one or more internal and/or external data sources, and perform a risk analysis on the data determine a risk level. The risk scoring system may include a server computer. The risk scoring system may receive the data in a risk score request message, and may send the generated risk score in a risk score response message.

The term “risk score” may be an indicator or value that indicates the riskiness of an action. The risk score may be the result of a risk analysis or evaluation. A risk score may be in the form of an alphanumeric value, such as a number from 1-10 or a letter from A-Z.

The term “data sources” may refer to a generally to an entity or system that provides data. A data source may be a source of data that is external to a system. In some embodiments, a data source may be located physically external from the system (e.g., in a separate physical location or separate computer), or may be located in a distinct location within a physical memory component within the system. A data source may be a source outside of a system firewall or located outside of a network of a company, system or entity. In other embodiments, a data source may refer to a source within the system.

In some embodiments, the data sources may include third party vendors that gather, analyze, and provide risk assessment data. In some embodiments, these third party vendors provide the risk assessment data for a fee. Data sources may also include sources, either internal or external to a system, which charge a fee for the retrieval and provision of data.

The term “device information” may refer to data regarding a device. The data from the device may include one or more of an IP address, a MAC address, browser data, operating system data, device type (e.g., data indicating that the device is a phone or card, or is made by a particular manufacturer), mobile device identifier, SIM card number, mobile application data, and GPS location. Device information may be retrieved from a memory in the device. Device information may also be referred to as “device data” and “information from a user device.”

The term “transaction data” may refer to information regarding a transaction. The information may include data for a financial transaction (e.g., payment data, transaction total, consumer data). The transaction data may be used for processing a financial transaction. Transaction data may include data for a specific transaction, including items purchased, item prices, total cost, shipping address, payment methods, authentication data, merchant data, etc. In some embodiments, transaction data may only be generated once the user or consumer attempts to submit a transaction for processing. In other embodiments, transaction data may be generated and sent by the merchant system based on items added to a consumer's shopping cart. In some embodiments, transaction data may include information for a non-financial transaction (e.g., alert data, incentive data, product data, etc.). The transaction data may be in any suitable format and may include any suitable information depending on the purpose of the transaction. Transaction data may also include transaction details.

The term “authorization process” may refer to a process of authorizing a transaction. In some embodiments, an authorization process may refer to the process of authorizing a form of payment presented by a user. The authorization process may involve the generation, transmission, reception, and evaluation of authorization messages by parties in the transaction. The payment authorization process may further involve evaluating user credentials, as well as evaluating account information related to the payment method presented in the transaction. The typical authorization process results in either an approval or denial of a transaction.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

The term “audit of the payment application server computer” may refer to an evaluation of the actions of the payment application server computer. In some embodiments, the audit of the payment application server computer may be conducted by a payment processing network or an issuer computer. The audit may include an evaluation of the authorization request messages transmitted by the payment application server computer and the risk scores associated with each of the transmitted authorization request messages. The audit of the payment application server computer may be conducted to determine whether the payment application server computer is transmitting authorization request messages for transactions that may have a high risk of fraud.

The term “payment processing network” may refer to a network that includes or operates at least one server computer used for payment processing. In some embodiments, the server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments, the payment processing network may operate multiple server computers. In such embodiments, each server computer may be configured to process transaction for a given region or handles transactions of a specific type based on transaction data. The server computer may be referred to as a “payment processing server.”

The payment processing network may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network may use any suitable wired or wireless network, including the Internet.

The payment processing network may process transaction request messages and determine the appropriate destination (e.g., issuer computer) for the transaction request messages. The payment processing network may also handle and/or facilitate the clearing and settlement of transactions.

### I. EXEMPLARY SYSTEMS

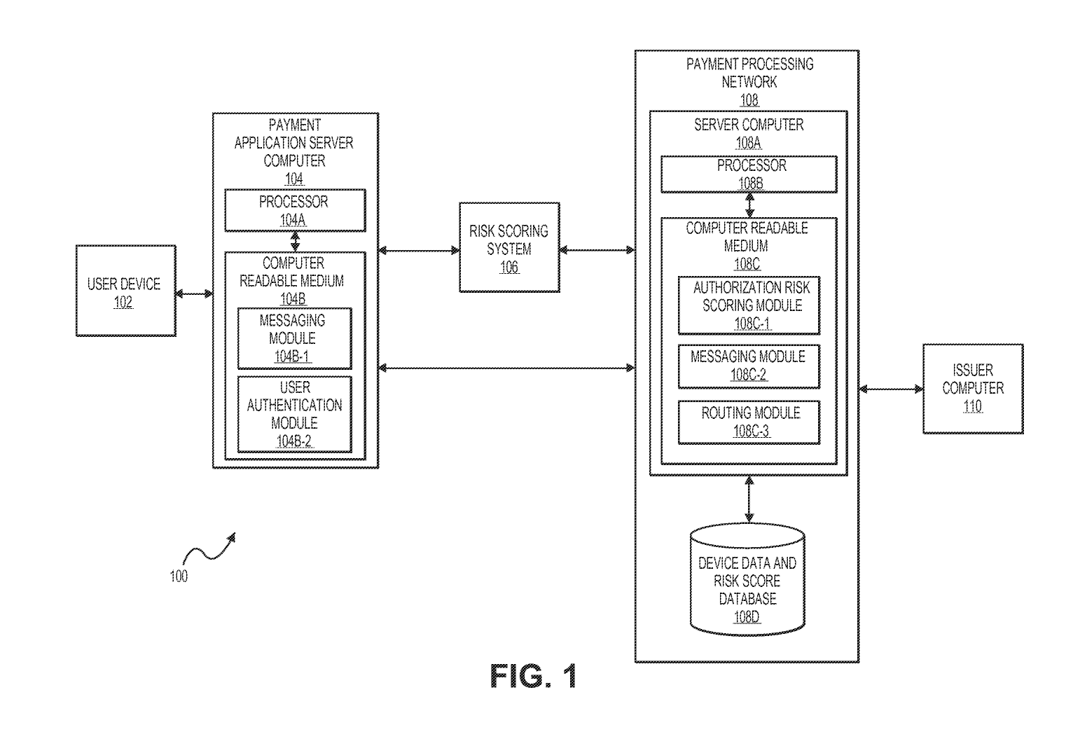

FIG. 1 shows a system diagram for a transaction processing system according to an embodiment of the present invention. The system 100 may be used to facilitate the communications of data between a user device 102 and a payment processing network 108. For simplicity of illustration, a certain number of components are shown is shown in FIG. 1. It is understood, however, that embodiments of the present invention may include more than one of each component. In addition, some embodiments of the present invention may include fewer than all of the components shown in FIG. 1.

The system 100 may include a user device 102, a payment application server computer 104, a risk scoring system 106, a payment processing network 108, and an issuer computer 110. Each of these systems and computers may be in operative communication with each other via any suitable communication medium (including the Internet), using any suitable communications protocol.

The user device 102 may be in any suitable form. For example, suitable user devices 102 can be hand-held and compact so that it can fit into a user's wallet and/or pocket (e.g., pocket-sized). The user device 102 can include a processor, and memory, input devices, and output devices, operatively coupled to the processor. Specific examples of uses devices 102 include cellular or wireless phones, personal digital assistants (PDAs), desktop computer, laptop computer, tablet computers, portable computers, smart cards, and the like.

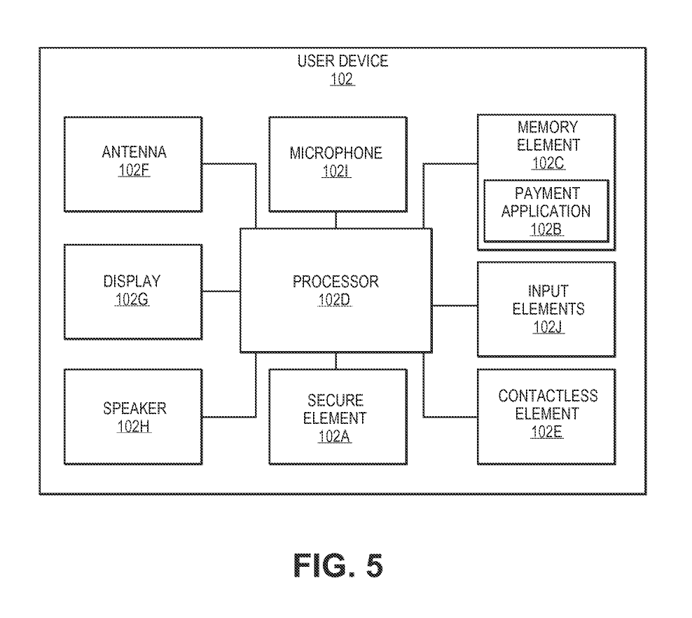

FIG. 5 depicts an exemplary block diagram of a user device 102 in the form of a mobile communication device (e.g., a mobile phone) according to an embodiment of the present invention. FIG. 5 shows a number of components, and the user device 102 according to embodiments of the present invention may comprise any suitable combination or subset of such components. The user device 102 may comprise a memory element 102C (e.g., computer readable medium) as shown in FIG. 5. The memory element 102C may be present within a body of the user device 102 or may be detachable from it. The body of the user device 102 may be in the form a plastic substrate, housing, or other structure. The memory element 102C may be a memory that stores data and may be in any suitable form including a magnetic stripe, a memory chip, uniquely derived keys (such as those described above), encryption algorithms, etc.

The memory element 102C may comprise a payment application 102B. The payment application 102B may be computer code or other data stored on a computer readable medium (e.g., memory element 102C or secure element 102A) that may be executable by the processor 102D to complete a task. The payment application 1028 may be an application that operates on the user device 102 that provides a user interface for user interaction (e.g., to enter and view information). In some embodiments, that payment application 102B may be a wallet application associated with a payment application server computer 104.

The payment application 102B may communicate with the payment application server computer 104 to retrieve and return information during the processing of any of a number of services offered to the user via the user device 102 (e.g., conducting transactions performed using the user device 102).

The secure element 102A may be a secure memory on the user device 102 such that the data contained on the secure element 102A cannot easily be hacked, cracked, or obtained by an unauthorized entity. The secure element 102A may be used by the user device 102 to host and store data and applications that may require a high degree of security. The secure element 102A may be provided to the user device 102 by a secure element issuer. The secure element 102A may be either embedded in the handset of the user device 102 or in a subscriber identity module (SIM) card that may be removable from the user device 102. The secure element 102A can also be included in an add-on device such as a micro-Secure Digital (micro-SD) card or other portable storage device.

The secure element 102A may store the same information such as financial information, bank account information, credit, debit, or prepaid account number information (or payment tokens associated with such credit, debit, or prepaid account numbers), account balance information, expiration dates, verification values such as CVVs or dCVVs, etc. Other information that may be stored in the secure element 102A may include consumer information such as name, date of birth, etc. In other embodiments, some, none or all of the foregoing information may be stored in the memory element 102C or may be stored at a remote server computer (e.g., in the cloud at the payment application server computer 104).

The user device 102 may further include a contactless element 102E, which may typically be implemented in the form of a semiconductor chip (or other data storage element) with an associated wireless transfer (e.g., data transmission) element, such as an antenna. Contactless element 102E may be associated with (e.g., embedded within) the user device 102 and data or control instructions transmitted via a cellular network may be applied to contactless element 102E by means of a contactless element interface (not shown). The contactless element interface may function to permit the exchange of data and/or control instructions between the user device circuitry (and hence the cellular network) and an optional contactless element 102E.

The contactless element 102E may be capable of transferring and receiving data using a near-field communications (NFC) capability (or NFC medium) typically in accordance with a standardized protocol or data transfer mechanism (e.g., ISO 14443/NFC). User devices 102 that support mobile contactless payments typically support contactless transactions using the EMV contactless communication protocol (EMV-CCP), which is based on ISO 14443, in order to interact with merchant access devices. This capability may typically met by implementing NFC. The NFC capability on the user device 102 may be enabled by an embedded NFC chip or by the addition of an external memory card or accessory that contains the NFC chip. NFC capability is a short-range communications capability, such as RFID, Bluetooth®, infra-red, or other data transfer capability that can be used to exchange data between the user device 102 and an interrogation device. Thus, the user device 102 may be capable of communicating and transferring data and/or control instructions via both cellular network and near-field communications capability.

The user device 102 may also include a processor 102D (e.g., a microprocessor) for processing the functions of the user device 102 and a display 102G to allow a consumer to see information and messages. The user device 102 may further include input elements 102j to allow a consumer to input information into the device, a speaker 102H to allow the consumer to hear voice communications, and a microphone 1021 to allow the user to transmit his or her voice through the user device 102. The user device 102 may also include an antenna 102F for wireless data transfer (e.g., data transmission).

In some embodiments, the display 102G of the mobile device 102 may also be a user interface that may allow the user to select or interact with objects presented on the display 102G, including, but not limited to menus, text fields, icons, and keys/inputs on a virtual keyboard. The display 102G may be configured to present an application (e.g., a payment application) or may be used to access and view a website associated with a merchant.

The payment application server computer 104 may include a processor 104A and a computer readable medium 104B coupled to the processor 104A, the computer readable medium 104B comprising code, executable by the processor 104A for performing the functionality described below. In some embodiments, the computer readable medium 104B may be comprised of a messaging module 104B-1 and a user authentication module 104B-2. In some embodiments, the code can be executable by a processor 104A to implement a method comprising: receiving, by a server computer, device information for a user device associated with a transaction; sending, by the server computer, a risk score request message including transaction details for the transaction and the device information for the user device to a risk scoring system; receiving, by the server computer, a first risk score for the user device from the risk scoring system; evaluating, by the server computer, the first risk score for the user device to determine whether to proceed with the transaction; determining, by the server computer, that the transaction should proceed; and generating and sending, by the server computer, an authorization request message for the transaction to another server computer

The payment application server computer 104 may manage and provide services to a user. In some embodiments, the services may be provided to the user via a payment application 102B associated with the payment application server computer 104 and stored on a user device 102. The payment application server computer 104 may send and receive over-the-air (OTA) messages to the payment application 102B stored on the user device 102.

In some embodiments, the payment application server computer 104 may receive a request from the user, via the payment application 1028, to perform a transaction using the user device 102. In such embodiments, the payment application server computer 104 may be configured to generate a risk score request message as part of an authentication process to authenticate the user device being used to perform a transaction. The payment application server computer 104 may be further configured to receive a risk score response message from the risk scoring system 106 indicating the result of the authentication process (e.g., the first risk score for the user device 102). In such embodiments, when the first risk score for the user device 102 is low or below a risk threshold, the payment application server computer 104 may be configured to send an authorization request message to an issuer computer 110 requesting that the transaction be authorized.

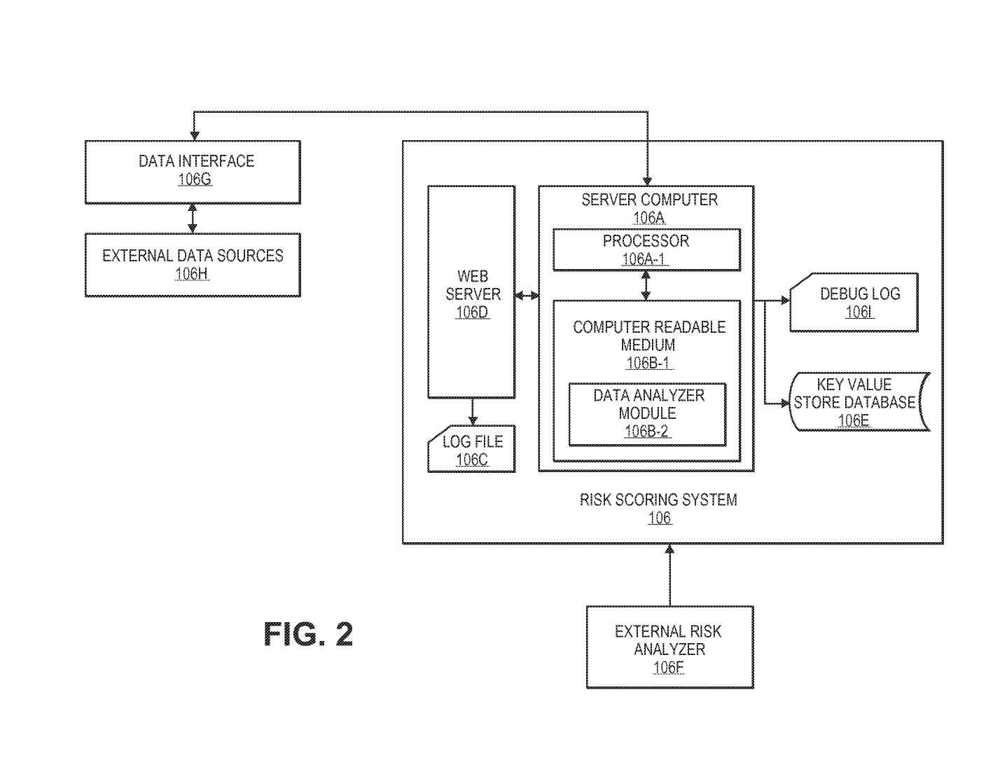

FIG. 2 depicts an exemplary block diagram of a risk scoring system 106 according to an embodiment of the present invention. As depicted in FIG. 2, the risk scoring system 106 may be comprised of a server computer 106A. The server computer 106A may include a processor 106A-1 and a computer readable medium 106B-1 coupled to the processor 106A-1, the computer readable medium 106B-1 comprising code, executable by the processor for performing the functionality described below. In some embodiments, the computer readable medium 106B-1 may be comprised of a data analyzer module 106B-2.

The risk scoring system 106 may also include a web server 106D, a log file module 106C, a key value store database 106E, and a debug log module 106I. The various modules may be embodied by computer code, residing on computer readable medium.

The web server 106D may electronically receive data messages that are transmitted from the payment application server computer 104 to the risk scoring system 106. The data messages received by the web server 106D may include risk score request messages requesting a risk score for a user device 102 associated with a transaction. In other embodiments, the request may be for an assessment regarding any type of interaction (e.g., accessing a website, provisioning an account). In some embodiments, the web server 106D receives the data message in the format of an HTML post data message. An exemplary web server 106D is an Apache Web Server, which is a public-domain open source web server. In embodiments of the present invention, the web server 106D, after receiving the data message, conducts an evaluation and validation of the data message. In some embodiments, the web server 106D determines whether the message has a virus attached to it. When the web server 106D finds a virus, it may remove the virus and clean the data message. In some embodiments, the web server 106D can also determine whether the query contained in the message is a valid query that may be asked. Once the web server 106D has cleaned and validated the message, it is sent to the data analyzer module 106B-2 for further processing.

The data analyzer module 106B-2 may receive the risk score request message from the web server 106D, and attempt to determine a risk score to respond to the risk score request message. In some embodiments, the data analyzer module 106B-2 may be able to generate the risk score for the user device 102 by evaluating past transaction data and past interaction data. In order to generate a risk score in response to the risk score request message, the data analyzer module 106B-2 may access data tables stored in the key value store database 106E. The data stored in the data tables in the key value store database 106E may be maintained and/or updated by an external risk analyzer 106F.

The log file module 106C may be used to store a record of every risk score request message received by the risk scoring system 106. In some embodiments, the response to the risk score request message is also stored in the log file module 106C. In some embodiments, the log file module 106C store past interaction data, external sources data, and similar users data.

The plurality of external data sources 106H may be accessed by the data analyzer module 106B-2 in the risk scoring system 106 through the data interface 106G via an external data communication channel. The of external data sources 106H that may be accessed through the external data communication channel may be comprised of one or more of, but are not limited to, the following data sources: card verification value (CVV or CVV2) verifier, a device risk analyzer, a real-time fraud engine, a real-time address verifier, a login or identity verification service, a compromised event data evaluator, and risk condition codes. Other embodiments of the present invention contemplate the use of some, none, or all of these data sources, in addition to other data sources that may provide user device data.

The debug log module 106I may be used to store the records of how the risk score request message (or any other query) was processed by the risk scoring system 106 and how the risk scoring system 106 performed. In some embodiments, the data in the debug log module 106I may be used to gauge system performance of the risk scoring system 106.

As depicted in FIG. 1, the payment processing network 108 may be comprised of a server computer 108A. The server computer 108A may include a processor 108B and a computer readable medium 108C coupled to the processor 108B, the computer readable medium 108C comprising code, executable by the processor for performing the functionality described below. The computer readable medium 108C may be comprised of an authorization risk scoring module 108C-1, a messaging module 108C-2, and a routing module 108C-3. The various modules may be embodied by computer code, residing on the computer readable medium 108C.

As noted above, the payment processing network 108 may have or operate at least a server computer 108A. In some embodiments, the server computer 108A may be coupled to a database and may include any hardware, software, other logic, or combination of the preceding for servicing the requests from one or more client computers. The one or more databases may include a device data and risk score database 108D. The server computer 108A may comprise one or more computational apparatuses and may use any of a variety of computing structures, arrangements, and compilations for servicing the requests from one or more client computers.

In some embodiment, the server computer 108A may comprise a processor 108B, and a computer readable medium 108C coupled to the processor 108B. The computer readable medium 108C comprises code, executable by the processor 108B, for implementing a method comprising: storing, by the server computer, at least one of the first risk score and the information from the user device in a database; receiving, by the server computer, an authorization request message including transaction data for a transaction; retrieving, by the server computer, the first risk score or the information from the user device from the database; matching, by the server computer, the authorization request message with the first risk score or the information from the user device; generating, by the server computer, a second risk score for the transaction based on the transaction data and the first risk score or the information from the user device; modifying the authorization request message to include the second risk score; and transmitting, by the server computer, the modified authorization request message to an issuer computer for an authorization determination.

The payment processing network 108 may include data processing subsystems, networks, and operations used to support and deliver authorization services, exception file services, and clearing and settlement services. An exemplary payment processing network 108 may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The payment processing network 108 may use any suitable wired or wireless network, including the Internet.

An authorization request message may be a message sent requesting that an issuer computer 110 authorize a financial transaction. An authorization request message may comply with ISO 8583, which is a standard for systems that exchange electronic transactions made by users using payment devices. An authorization request message according to other embodiments may comply with other suitable standards. In some embodiments of the present invention, an authorization request message may include, among other data, a Primary Account Number (PAN) and expiration date associated with a payment device (e.g., credit/debit card) of the user, transaction amount (which may be any type and form of a medium of exchange such a money or points), category identification of a merchant (e.g., merchant ID). In some embodiments, an authorization request message may be generated by a server computer or by a merchant access device (e.g., a point of sale device) and is sent to an issuer computer 110 via the payment processing network 108.

An authorization response message may be a message sent from the issuer computer 110, in response to an authorization request message. The typical authorization response message includes an indication as to whether the authorization has been either approved or declined. An authorization response message may comply with ISO 8583, which is a standard for systems that exchange electronic transactions made by users using payment devices.

The messaging module 108C-2 may send and receive authorization request messages and authorization response messages. The messaging module 108C-2 may receive authorization request messages from and send authorization response messages to the payment application server computer 104, as well as send authorization request messages to and receive authorization response messages from the issuer computer 110. The messaging module 108C-2 may further receive messages from the risk scoring system 106. The messages from the risk scoring system 106 may include a risk score for user device associated with a transaction and device information for the user device.

The routing module 108C-3 may handle the routing of authorization request messages from the payment application server computer 110 to the issuer computer 110, and routing the authorization response messages back from the issuer computer 110 to the payment application server computer 110.

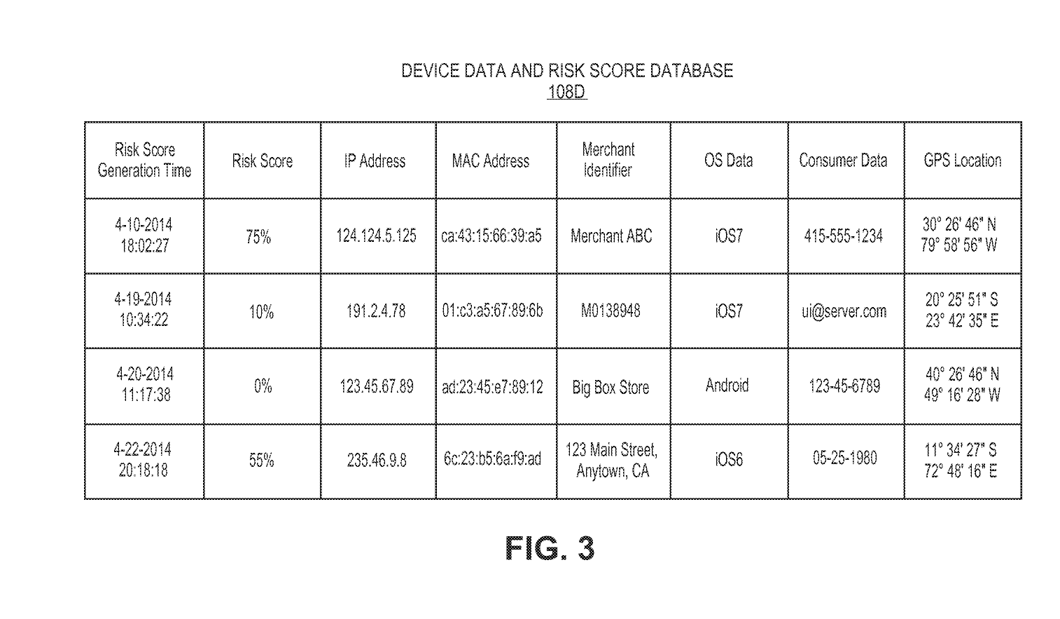

FIG. 3 shows an example device data and risk score database 108D according to an embodiment of the present invention. The device data and risk score database 108D may store data received from the risk scoring system 106.

As shown in FIG. 3, the device data and risk score database 108D may be organized by risk score generation time. In some embodiments, each risk score may have a separate row composed of data associated with the risk score. The device data and risk score database 108D may store data in a plurality of categories, including “Risk Score Generation Time”, “Risk Score”, “IP Address”, “MAC Address”, “Merchant Identifier”, “Operating System (OS) Data”, “Consumer Data”, and “GPS Location”. The data stored in the device data and risk score database 108D may be data associated with a user device 102, a user (or consumer), and/or a merchant. Some embodiments may have fewer or additional categories for data. The values shown in the exemplary device data and risk score database 108D of FIG. 3 are for illustration purposes only and are not meant to limit the different types of data and identifiers that may be stored and used in the device data and risk score database 108D.

An issuer computer 110 is typically associated with a business entity (e.g., a bank). The issuer computer 110 may include a processor and a computer readable medium coupled to the processor, the computer readable medium comprising code, executable by the processor for performing the functionality described below. The issuer computer 110 may maintain financial accounts for a user or consumer, and can issue payment devices, such as a credit or debit card to the user.

### II. EXEMPLARY METHODS

Methods according to embodiments of the present invention can be described with respect to FIGS. 1-4.

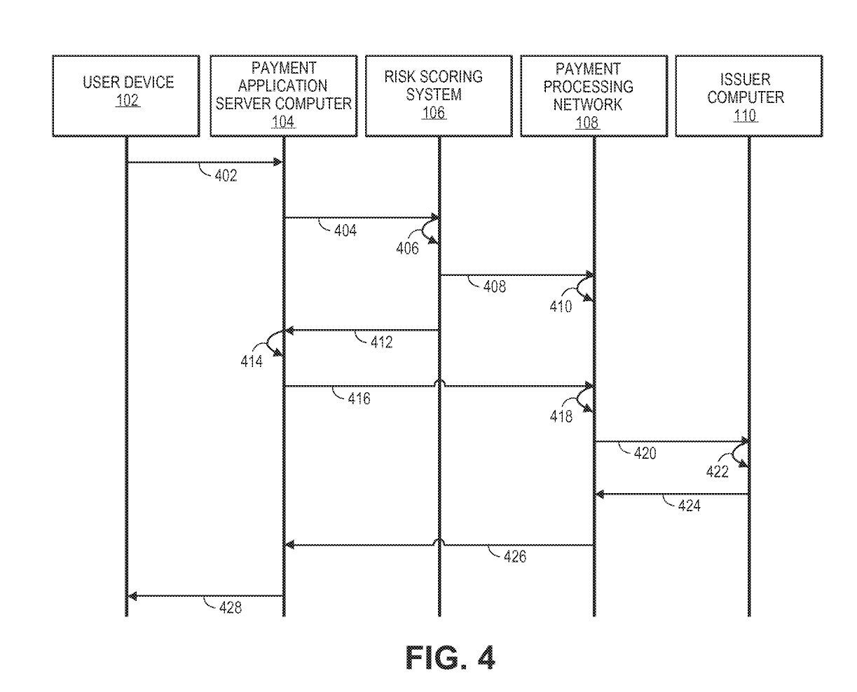

FIG. 4 shows an example message flow diagram for an authentication and authorization process for a transaction according to an embodiment of the present invention. Although a certain number of components are depicted in FIG. 7, there may be additional components not depicted that may interact with the shown components. Other embodiments may have fewer than all the components shown in FIG. 4.

In step 402, a user (e.g., a consumer) may initiate a process of performing a transaction. In some embodiments, the user may access a payment application 102B stored in a memory element 102C of a user device 102 in the form of a mobile device. The payment application 102B may be computer code or other data stored on a computer readable medium (e.g., memory element 102C or secure element 102A) that may be executable by a processor to complete a task. The payment application 102B may provide a user interface for user interaction (e.g., to enter and view account information, send payments). The payment application 102B may communicate with a payment application server computer 104 to retrieve and return information during the processing of services offered to the user via the user device 102 (e.g., provisioning new accounts, sending mobile payments). Additionally, the payment application 102B can communicate with the payment application server computer 104 to send and receive over-the-air (OTA) messages. The payment application 102B may provide the functionality to manage and maintain the user payment information and support mobile payments. The user may select an item for purchase and select a “Buy” or “Checkout” option provided by the payment application 102B.

In some embodiments, the user may access a merchant's website using the user device 102. The user may access the merchant's website using an internet browser application stored on a memory in the user device 102. The merchant's website may be hosted on a merchant computer. Once the user has selected goods or services via the merchant's website, the user may proceed through a checkout process.

In some embodiments, the payment application 102B may send data to the payment application server computer 104 when the user begins a transaction or a checkout process. In some embodiments, the payment application server computer 104 may want a risk analysis and a risk score associated with the user device 102 when the user initiates a checkout process for a transaction. In some embodiments, the payment application server computer 104 may want the risk analysis and the risk score for the user device 102 associated with any interaction, such as a change to an email address, a change to a shipping address, and/or the user browsing items or attempting to access specific content.

In some embodiments, the payment application server computer 104 may be configured to receive user device information for the user device 102 associated with the transaction. In other embodiments, the user device 102 may be configured to send device data as part of the checkout process. The data may include user device information (e.g., IP address, MAC address, browser data, operating system data, mobile device identifier, payment application data), payment device data, geo-location data (e.g., GPS location data, address), user data (e.g., address, email address, phone number, social security number, date of birth), transaction details (e.g., items in shopping cart, SKU numbers, price for items), account data, or other comparable data. In other embodiments, some or all of this data may be requested and/or retrieved by the payment application server computer 104.

In step 404, the payment application server computer 104 receives the user device information from the payment application 102B stored on the user device 102. The payment application server computer 104 may be configured to send a risk score request message to a risk scoring system 106 requesting that a risk analysis be conducted for the user device 102. The risk score request message may be generated by the payment application server computer 104 and may include the data received from the payment application 104 stored on the user device 102, including the user device information and the transaction details. The risk score request message may be sent using a messaging module 104B-1 stored in a computer readable medium of the payment application server computer 104.

In step 406, the risk scoring system 106 may receive the risk score request message from the payment application server computer 104. The risk score request message received by the risk scoring system 106 may include transaction details for a transaction and device information for a user device 102 being used to conduct the transaction and associated with the payment application server computer 104.

The risk scoring system 106 may then perform a first risk analysis for the user device 102 using one or more of the user device information, payment device data, geo-location data, user data, transaction details, and the account data. The first risk analysis may include a process of generating a first risk score indicating the risk level of the user device 102 associated with the transaction.

The first risk analysis may be any suitable risk analysis process. The first risk analysis may compare device information and/or transaction details with historical databases of similar information for past transactions in a database. Such past transactions may have been determined to be fraudulent or not fraudulent. The device information and/or transaction details may also be compared with information in a hot list of known fraudulent transactions. Other risk analysis processes may utilize neural networks, genetic algorithms, clustering, regression analysis, etc.

The first risk analysis may be performed by the risk scoring system 106 by querying one or more internal and/or external data sources, and retrieving risk data associated with the user device 102 from the one or more internal and/or external data sources. The data retrieved from internal and/or external data sources may be analyzed by a data analyzer module 108B-2. The data analyzer module 108B-2 may use the result of the analysis (e.g., the first risk analysis) to generate a first risk score for the user device 102. Other aspects of suitable risk scoring systems may be found in U.S. patent application Ser. No. 13/706,226, filed on Dec. 5, 2012, which is assigned to the same assignee as the present application and is herein incorporated by reference in its entirety for all purposes.

In step 408, the risk scoring system 106 may send or transmit the first risk score and the device information to a second server computer (e.g., a server computer 108A in a payment processing network 108). The data sent to the payment processing network 108 may include all or some of the information used by the risk scoring system 106 to derive the first risk score. The first risk score and the device information may be received using a messaging module 108C-2 stored in a computer readable medium of the server computer 108A in the payment processing network 108.

In some embodiments, the risk scoring system 106 may also send transaction details for the transaction, including a merchant identifier, transaction amount, shopping cart data, or other data related to the transaction. In such embodiments, the transaction details for the transaction may be additional data used by the payment processing network 108 to match the first risk score with a received authorization request message.

In step 410, the payment processing network 108 stores the received risk score and/or the device information for the user device 102 in the database 108D. In some embodiments, the server computer 108A in the payment processing network 108 may receive the risk score and the device information for the user device by a messaging module 108C-2. The server computer 108A may then access a device data and risk score database 108D and store the risk score and/or the device information for the user device in the device data and risk score database 108D. The data stored in the device data and risk score database 108D may include one or more of a “Risk Score Generation Time”, “Risk Score”, “IP Address”, “MAC Address”, “Merchant Identifier”, “Operating System (OS) Data”, “Consumer Data”, and “GPS Location” associated with the merchant, the user device and/or the user.

In step 412, the risk scoring system 106 may send or transmit a risk score response message including the first risk score to the payment application server computer 104.

In step 414, the payment application server computer 104 may evaluate the first risk score for the user device 102 received in the risk score response message. The evaluation of the first risk score may be to determine whether to proceed with the transaction or to stop the transaction from continuing.

The evaluation of the first risk score may be performed using a user authentication module 104B-2 stored in the computer readable medium 104B of the payment application server computer 104. The user authentication module 104B-2 may evaluate the first risk score to determine whether the first risk score is above a risk threshold. The risk threshold may be established by the payment application server computer 106 as a cut-off for allowing or denying transactions. The risk threshold may be set at any value. For example, the payment application server computer 106 may establish conditions or rules that when the risk score is above 30%, the transaction should be denied as the risk level may be considered. If the risk level is below 30%, the transaction may be allowed. In some embodiments, the risk threshold may be established by a merchant, the payment processing network 108, or an issuer.

In step 416, when the user authentication module 104B-2 determines that the transaction should proceed (e.g., the first risk score for the user device 102 is below the risk threshold), the messaging module 104B-1 in the payment application server computer 104 may generate an authorization request message for the transaction. The authorization request message may be used to request authorization of a payment method provided by the user to perform the transaction. The authorization request message may include, at least, payment device data, merchant data, and a transaction amount. The authorization request message for the transaction may be sent by the messaging module 104B-1 to the payment processing network 108. In some embodiments, the authorization request message may be an ISO 8583 payment authorization request message. ISO 8583 specifies a common message interface that allows financial data messages for a transaction to be interchanged between acquirers, issuers, and payment processing networks.

In step 418, the payment processing network 108 may receive the authorization request message for the transaction from the payment application server computer 104.

An authorization risk scoring module 108C-1 in the server computer 108A may be configured to retrieve the first risk score from the device data and risk score database 108D. In some embodiments, the authorization risk scoring module 108C-1 may be configured to retrieve the user device information for the user device 102 from the device data and risk score database 108D.

The authorization risk scoring module 108C-1 may match the authorization request message with the first risk score or the user device information. In some embodiments, matching the authorization request message with the first risk score may be conducted by a filtering logic operation. The filtering logic operation may use one or more of a transaction time, an authorization request message time, and risk score generation time. In some embodiments, the data stored in the device data and risk score database 108D may be compared with the authorization request message.

For example, the authorization risk scoring module 108C-1 may determine a transaction time of Apr. 19, 2014, 10:34:45 for a received transaction from a merchant (“M0138948”). The authorization risk scoring module 108C-1 may locate an entry in the device data and risk score database 108D for the merchant with merchant identifier “M0138948”. The authorization risk scoring module 108C-1 may use the filtering logic operation to match the received transaction to the first risk score generated on Apr. 19, 2014, at 10:34:22 (as shown in FIG. 3). The first risk score associated with that stored first risk score entry may be 10%.

In other embodiments, the authorization request message may include device information for the user device 102, including but not limited to, an IP address and a MAC address. In such embodiments, the authorization risk scoring module 108C-1 may parse the authorization request message to retrieve the device for information for the user device 102 associated with the transaction. The retrieved device information (e.g., IP address, MAC address) may be queried against the device data and risk score database 108D to retrieve the first risk score associated with the user device 102.

In yet other embodiments, the risk scoring system 106 may have generated a transaction identifier with the first risk score and may have transmitted both the transaction identifier and the first risk score to the first and second server computers 104, 108A. The first server computer 104 may include both pieces of data in the authorization request message. When the second server computer 108A receives the transaction identifier, it can match it with the previously received transaction identifier.

If data in the device data and risk score database 108D has not been matched with an incoming transaction after a predetermined period of time (e.g., one hour or one day), it can be assumed that the payment application server computer 104 decided not to send an authorization request message. In some embodiments of the present invention, such data may be deleted or purged after the predetermined period of time has lapsed.

When the authorization risk scoring module 108C-1 has retrieved the appropriate first risk score associated with the transaction from the device data and risk score database 108D, the authorization risk scoring module 108C-1 may use the first risk score and the transaction data for the transaction in the authorization request message to generate a second risk score. The second risk score may be based on the first risk score for the user device 102, the transaction data, the payment device data, consumer data, and/or merchant data.

When the authorization risk scoring module 108C-1 has generated the second risk score, the messaging module 108C-2 in the server computer 108A may be configured to modify the authorization request message from the payment application server computer 104 to include the second risk score. The second risk score may be inserted into an unused field in the authorization request message or may be appended to the authorization request message prior to being sent to an issuer computer 110.

The routing module 108C-3 may be configured to determine the appropriate issuer computer 110 associated with the payment device used for the transaction. The routing module 10C-3 may evaluate an account number or a bank identification number (BIN) to determine the appropriate issuer computer 110 associated with the payment device. The routing module may route the modified authorization request message to the issuer computer 110.

In step 420, the routing module 108C-3 in the server computer 108A of the payment processing network 108 may transmit the modified authorization request message to an issuer computer 110 associated with the payment device provided by the user for the transaction. The message may be sent by an appropriate messaging means, including over a communications network (e.g., the Internet).

In step 422, the issuer computer 110 receives the modified authorization request message from the payment processing network 108. The modified authorization request message may include the second risk score calculated by the authorization risk scoring module 108C-1 in the payment processing network 108. The issuer computer may parse out the payment details for the transaction (e.g., user account number, payment card data, address data) and the transaction details for the transaction (e.g., merchant identifier, transaction total), and determine whether the payment device provided by the user for the transaction should be allowed or rejected. The authorization process for the payment device provided by the user for the transaction may include determining an available balance or an available credit balance for a payment account associated with the payment device. If there are insufficient funds to pay for the transaction total of the transaction, the authorization process may be declined by the issuer computer 110.

In step 424, when the issuer computer 110 has performed and completed the authorization process, the issuer computer 110 may generate and send an authorization response message for the transaction. The authorization response message may indicate whether the transaction has been approved or rejected by the issuer computer 110. In some embodiments, the authorization response message may comply with ISO 8583, which is a standard for systems that exchange electronic transactions made by users using payment devices.

In step 426, the payment application server computer 104 receives an authorization response message from the issuer computer 110. The authorization response message may include the result of the authorization process indicating whether the payment device or payment account was authorized by the issuer computer 110 for the transaction. The payment application server computer 104 may parse the received authorization response message to determine whether the issuer computer 110 approved or declined the transaction.

In step 428, the payment application server computer 104 may provide the result of the authorization process to the user via the user device 102. After evaluating the authorization response message received from the issuer computer 110, the payment application server computer 104 may either proceed with the transaction and finalize the transaction, or stop the transaction. In other embodiments, as the payment application server computer 104 would be assured of the authenticity of the user and the user device 102 (e.g., based on the first risk score), the payment application server computer 104 may not want to cancel the transaction, and may ask the user to submit another payment device for use for the transaction. For example, the payment application server computer 104 may generate and send a message using the messaging module 104B-1 indicating that the transaction has been approved or rejected by the issuer computer 110.

### III. ADDITIONAL EMBODIMENTS

In an additional embodiment of the present invention, when the payment processing network 108 receives the authorization request message, the authorization risk scoring module 108C-1 may generate a third risk score based on the data included in the authorization request message. In such embodiments, the third risk score may not be based on the user device information for the user device 102 used in the transaction. In such embodiments, the authorization risk scoring module 108C-1 may use the first risk score and the third risk score to generate the second risk score that will be sent to the issuer computer 110 in the modified authorization request message. By generating the third risk score just for the transaction data in the authorization request message, the payment processing network 108 may be able to determine and store data regarding the risk level of the transaction without the user device information for the user device 102 used in the transaction.

In an additional embodiment of the present invention, in addition to the device information for the user device 102, the payment application server computer may also request user data for the user associated with the user device 102. In such embodiments, the user data received from the user may be sent to the risk scoring system 106, and may be used by the risk scoring system 106 to generate the first risk score. The user data may also be sent to the payment processing network 108 by the risk scoring system 106. In such embodiments, the user data may be stored in the device data and risk score database 1088, or may be stored in a separate database.

In an alternative embodiments of the present invention, a payment processing network 108 and/or an issuer computer 110 may retrieve a set of authorization request message previously received from a payment application server computer 104. The payment processing network 108 and/or the issuer computer 110 may retrieve a set of risk score from the device data and risk score database 108D. The payment processing network 108 and/or the issuer computer 110 may then perform an audit of the payment application server computer 104 based on the set of authorization request messages and the corresponding set of risk scores.

In such embodiments, the audit may be performed to determine whether the payment application server computer 104 is generating and sending authorization request messages for transaction that may be risky (based on the first risk score generated for the user device 102). For example, if a payment application server computer 104 is routinely processing transactions with high risk scores, the payment processing network 108 and/or the issuer computer 110 may want to monitor future transactions passing through the payment application server computer 104, or may consider declining or blocking transactions passing through the payment application server computer 104.

### IV. TECHNICAL BENEFITS

Embodiments of the present invention provide the technical benefits of improving the efficiency of transaction-related processes and conserving resources of entities involved in transactions. One benefit provided by embodiments of the present invention is that a first risk score can be determined before a consumer ever engages in a transaction. The first risk score may indicate a risk level associated with a user device based on device information sent to a risk scoring system. For example, when the user device accesses a merchant website or a payment application stored on the user device, the first risk score may be determined. This may occur as the user is browsing for goods or services and/or at any other point where the user is interacting with the merchant website or the payment application. This has the benefit of allowing the merchant and/or payment application server computer to have a first risk score associated with the user device prior to any transaction occurring. Thus, when the first risk score indicates a high risk, when the user attempts to conduct a transaction (e.g., adds items to a shopping cart, attempts to begin a checkout process), the transaction may be prevented from being initiated or processed. This may result in the conservation of system resources, as authorization-related messages may not be generated when the payment application server computer has already identified a high risk level associated with the user device and transactions being attempted by the user device.

In addition, as the first risk score and the device information are also provided to the payment processing network, when the payment processing network receives an authorization request message for the transaction, the appropriate first risk score may be matched with the authorization request message. This allows the first risk score to be used to further verify the transaction. As a typical authorization request message does not contain detailed device information for a user device engaged in the transaction, embodiments of the present invention provide additional data that would not customarily be processed by the payment processing network. The payment processing network may also use the first risk score to generate a second risk score (based on the transaction data included in the authorization request message and the device data used to generate the first risk score). The second risk score may then be provided to an issuer computer in a modified authorization request message.

The issuer associated with the issuer computer also benefits by having the device information and first risk score included in the modified authorization request message (e.g., either as the second risk score or separately as fields in the modified authorization request message). The issuer may then determine whether the transaction should be authorized or rejected based off the second risk score.

Embodiments of the present invention allow the issuer computer to make its own decision as to the authenticity of the user device and the riskiness of approving the transaction with the user device. For example, in some embodiments, the issuer may have a higher risk threshold than the payment application server computer. In such embodiments, the issuer may reject a transaction that was deemed low risk by the payment application server computer. With the additional information sent from the risk scoring system to the payment processing network, and incorporated in the modified authorization request message, the issuer computer can check or verify the decision by the payment application server computer to proceed with the transaction. Using embodiments of the present invention, the issuer can obtain more information to determine the risk of a transaction than was otherwise possible to obtain in the past.

### V. EXEMPLARY APPARATUSES

The various participants and elements, such as, e.g., the mobile gateway, described herein with reference to the figures may operate one or more computer apparatuses to facilitate the functions described herein. Any of the elements in the figures, including any servers or databases, may use any suitable number of subsystems to facilitate the functions described herein.

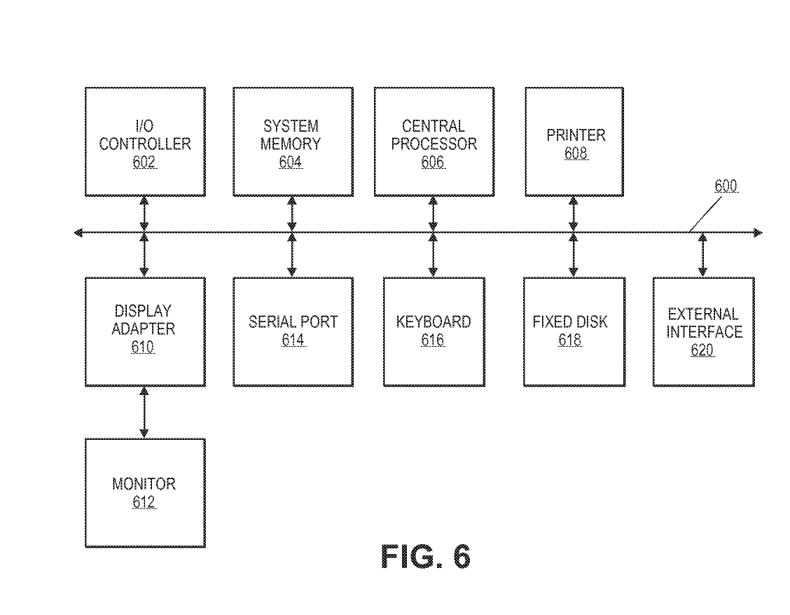

Examples of such subsystems or components are shown in FIG. 6. The subsystems shown in FIG. 6 are interconnected via a system bus 600. Additional subsystems such as a printer 608, keyboard 614, fixed disk 616 (or other memory comprising computer readable media), monitor 620, which is coupled to display adapter 610, and others are shown. Peripherals and input/output (I/O) devices, which couple to I/O controller 602 (which can be a processor or other suitable controller), can be connected to the computer system by any number of means known in the art, such as serial port 612. For example, serial port 612 or external interface 618 can be used to connect the computer apparatus to a wide area network such as the Internet, a mouse input device, or a scanner. The interconnection via system bus allows the central processor 606 to communicate with each subsystem and to control the execution of instructions from system memory 604 or the fixed disk 616, as well as the exchange of information between subsystems. The system memory 604 and/or the fixed disk 616 may embody a computer readable medium.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. While the present invention has been described using a particular combination of hardware and software in the form of control logic and programming code and instructions, it should be recognized that other combinations of hardware and software are also within the scope of the present invention. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

In some embodiments, any of the entities described herein may be embodied by a computer that performs any or all of the functions and steps disclosed.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, at least one of information from a user device and a first risk score generated by a first risk scoring system, the first risk scoring system generating the first risk score after receiving the information from the user device;
storing, by the server computer, at least one of the first risk score and the information from the user device in a database;
receiving, by the server computer, an authorization request message including transaction data for a transaction;
retrieving, by the server computer, the first risk score or the information from the user device from the database;
matching, by the server computer, the authorization request message with the first risk score or the information from the user device;
generating, by the server computer, a second risk score for the transaction based on the transaction data and the first risk score or the information from the user device;
modifying the authorization request message to include the second risk score; and
transmitting, by the server computer, the modified authorization request message to an issuer computer for an authorization determination.

2. The method of claim 1, wherein receiving comprises receiving the first risk score, storing comprises storing the first risk score, retrieving comprises retrieving the first risk score, matching comprises matching the first risk score with the authorization request message, and generating the second risk score comprises generating the second risk score based on the first risk score.

3. The method of claim 1, wherein matching the authorization request message with the first risk score or the information from the user device comprises:
performing, by the server computer, a filtering logic operation.

4. The method of claim 3, wherein the filtering logic operation uses one or more of a transaction time, an authorization request message time, and a risk score generation time, to match the authorization request message to the first risk score of the information from the user device.

5. The method of claim 1, wherein matching the authorization request message with the first risk score or the information from the user device comprises:
parsing, by the server computer, the authorization request message to retrieve device information for a user device associated with the transaction; and
querying, by the server computer, the database with the device information.

6. The method of claim 1, further comprising:
retrieving, by the server computer, a set of authorization request messages received from a payment application server computer;
retrieving, by the server computer, a set of risk scores, each risk score in the set of risk scores associated with a different authorization request message in the set of authorization request messages; and
performing, by the server computer, an audit of the payment application server computer based on the set of authorization request messages and the set of risk scores.

7. A server computer comprising:
a processor; and
a computer readable medium coupled to the processor, the computer readable medium comprising code, executable by the processor implementing the method of claim 1.

8. A method comprising:
receiving, by a first server computer, a risk score request message from a payment application server computer including transaction details for a transaction and device information for a user device being used to conduct the transaction and associated with the payment application server computer;
performing, by the first server computer, a first risk analysis for the user device based on the transaction details and the device information for the user device;
generating, by the first server computer, a first risk score based on the first risk analysis;
sending, by the first server computer, a risk score response message including the first risk score to the payment application server computer; and
transmitting, by the first server computer, the first risk score and the device information to a second server computer.

9. The method of claim 8, wherein the first server computer is a server computer in a risk scoring system.

10. The method of claim 8, wherein performing the first risk analysis for the user device comprises:
querying, by the first server computer, one or more internal or external data sources; and
retrieving, by the first server computer, risk data associated with the user device from the one or more internal and external data sources.

11. The method of claim 8, further comprising:
sending, by the first server computer, transaction details to the second server computer, the transaction details being used to match the first risk score with an authorization request message for the transaction.

12. The method of claim 8, wherein the device information for the user device includes one or more of an IP address, a MAC address, browser data, operating system data, mobile device identifier, mobile application data, and GPS location.

13. A server computer comprising:
a processor; and
a computer readable medium coupled to the processor, the computer readable medium comprising code, executable by the processor implementing the method of claim 8.

14. A method comprising:
receiving, by a first server computer, device information for a user device associated with a transaction;
sending, by the first server computer, a risk score request message including transaction details for the transaction and the device information for the user device to a risk scoring system;
receiving, by the first server computer, a first risk score for the user device from the risk scoring system;
evaluating, by the first server computer, the first risk score for the user device to determine whether to proceed with the transaction;
determining, by the first server computer, that the transaction should proceed; and
generating and sending, by the first server computer, an authorization request message for the transaction to a second server computer.

15. The method of claim 14, wherein the first server computer is a payment application server computer.

16. The method of claim 14, wherein evaluating the first risk score for the user device comprises:
determining, by the first server computer, that the first risk score is below a predetermined risk threshold.

17. The method of claim 14, further comprising:
receiving, by the first server computer and from the second server computer, an authorization response message indicating an authorization result.

18. The method of claim 14, further comprising:
requesting, by the first server computer, user data for a user associated with the user device;
receiving, by the first server computer, the user data; and
sending, by the first server computer, the user data in the risk score request message, wherein the user data is sent to the second server computer for an authorization process for the transaction.

19. The method of claim 18, wherein the user data includes one or more of a name, a date of birth, a social security number, a phone number, a physical address, and an email address.

20. A server computer comprising:
a processor; and
a computer readable medium coupled to the processor, the computer readable medium comprising code, executable by the processor implementing the method of claim 14.
